(19) United States
(12) Patent Application Publication
(10) Pub. No.: US 2003/0167929 A1
(43) Pub. Date: Sep. 11, 2003

(54) High soluble dietary fibre fermented beverage and process for its production

(76) Inventors: Malcolm Brier, Auckland (NZ); Jayarama K Shetty, Pleasanton, CA (US); Alan W King, Auckland (NZ)

Correspondence Address: Genencor International Inc, 925 Page MIll Road, Palo Alto, CA, 94304-1013, US

(21) Appl. No.: 10/363,947

(22) PCT Filed: Sep. 3, 2001
(86) PCT No.: PCT/NZ01/00180

(30) Foreign Application Priority Data
Sep. 5, 2000 (NZ) 506781

(51) Int. Cl. A47J 31/00

(52) U.S. Cl. 99/279

(57) ABSTRACT

The invention is directed to a brewing process for making a fermented product having an increased dietary fibre content and to a fermented product having an increased content of soluble dietary fibre.

### TECHNICAL FIELD

The invention relates to a process for the production of a fermented product having an increased dietary fibre content and also to a product having an increased soluble dietary fibre content.

### BACKGROUND ART

Methods of producing fermented products such as beer are well known. Essentially, the brewing process for making beer, ale, and other malt beverages commences with malt from conventional malting processes, milling or preparation of a mash from the ground malt, where starch converts to sugars, a filtration process to produce liquid wort, flavouring the wort with hops, boiling the wort, fermenting this mixture with a yeast, drawing off the fermented wort (now called beer) to maturation, and then filtration and bottling of the beer.

The final beer contains a variety of components including alcohol, water, and a variety of digestible and non-digestible sugars. The alcohol content and the digestible sugar content both contribute to the caloric content of the fermented product produced, although most of the caloric content is attributable to the alcohol component. The number of calories available from the digestible sugars arises due to the non-conversion of all sugars into alcohol during the fermentation process and this results in a residual caloric effect in addition to the primary alcohol caloric effect.

The benefits of dietary fibre consumption are well known. These benefits can be provided by increased intake of insoluble or soluble dietary fibre. Soluble dietary fibre can be defined as being those complex carbohydrates that are not readily digested by the human digestive system but remain largely intact to be utilised by the microflora in the lower gut. As such the term will include the fructo-oligosaccharides and non-digestible isomalto-oligosaccharides.

There is therefore an advantage in being able to provide a process that will result in a fermented product having an increased level of soluble dietary fibre.

The production of a fermented product such as a beer or ale having a low digestible sugar content and thereby a lower residual calorie effect, while maintaining alcohol content and consumer acceptability, is difficult to achieve. Simply removing digestible sugars from the fermented product results in lower consumer acceptability due to an unacceptable taste and the beer lacking body and mouthfeel. There is a benefit in being able to provide a process that will go some way to producing a product having such consumer acceptability.

At present fermented products have little or no dietary fibre benefit to the consumer. It would be an advantage to be able to produce a fermented product having a increased dietary fibre content, resulting in a product with improved health benefits, whilst maintaining consumer acceptability. It would be an additional advantage to be able to produce a product having an increased dietary fibre content coupled with a low, or at least a reduced, calorie content.

Syrups containing isomalto-oligosaccharides have been added to fermented products in the past for taste and mouthfeel purposes. JP7-51045 (Sapporo) discloses addition of a syrup, to a beer and a sparkling wine, to affect taste and flavour of the final product and not for dietary fibre reasons. The commercially available syrup used contains low levels of non-digestible IMO, no fructo-oligosaccharides, and high levels of digestible IMO's (eg more than 25% panose). This is consistent with the aim of affecting the taste of the product. WO 00/24864 discloses a process for production of a beer of high nutritional value (by inclusion of high levels of β-glucan) from cereals. The process disclosed requires the avoidance of conventional malting processes to achieve a wort having a high β-glucan content. Such a process is therefore prone to problems as the malting process is a key process step that it is desirable not to change. Conventional malting processes remove β-glucan to facilitate the production of normal worts.

### OBJECT OF THE INVENTION

With the above background in mind, it is an object of the invention to at least go some way to meeting the perceived advantages, overcoming disadvantages or at least to provide the public with a useful choice.

### SUMMARY OF THE INVENTION

In a first aspect, the invention provides a brewing process for making a fermented product having an increased dietary fibre content, the process including the step of producing an additional component of soluble dietary fibre at a selected stage or stages in the process after malting.

Preferably, the process produces at least an additional 0.3 g/100 ml more preferably 0.5 g/100 ml, and most preferably at least 0.7 g/100 ml, of soluble dietary fibre.

Preferably, the soluble dietary fibre produced in the brewing process includes the non-digestible isomalto-oligosaccharides, and/or fructo-oligosaccharides.

Preferably, the isomalto-oligosaccharides produced include one or more of isomaltotriose, isomaltopentose, isomaltohexose, 4-alpha-dextrantriosyl-D-glucose, 4-alpha-dextrantetrosyl-D-glucose, 4-alpha-dextranpentosyl-D-glucose, 6³-α-D-glucosyl maltotriose, isomaltose and panose.

Preferably, the soluble dietary fibre is produced enzymatically during the brewing process.

Preferably, the soluble dietary fibre is derived from the transglycosylation of glucose or fructose.

Preferably, the soluble dietary fibre is an isomalto-oligosaccharide produced enzymatically from maltose and/or malto oligosaccharides , in which process the maltose is maintained at above 2%w/v, preferably between 15% and 80%, and more preferably between 25% and 40%w/v, in the mix prior to enzymatic conversion.

Preferably the enzyme is added during the mashing or wort preparation process.

Preferably, the product produced by the process contains at least about 2.5 g/100 ml of soluble dietary fibre and more preferably more than about 4 g/100 ml. More preferably the minimum amount of the soluble dietary fibre produced is above about 0.3 g/100 ml.

Preferably the product also includes less than about 8.0 g/100 ml of digestible sugar.

Preferably, the process includes the steps of selectively removing the digestible sugars either by adding a yeast which selectively ferments digestible sugars or by extending the fermentation process sufficiently to ferment remaining digestible sugars.

Preferably, the product includes less than about 4 g/100 ml of digestible sugar, more preferably less than 2.0 g/100 ml.

Preferably, the brewing process includes the steps of preparation of a mash containing malted barley and adjuncts, extracting wort from the mash, boiling the wort, fermenting the wort with a yeast to produce beer.

Preferably, the wort is flavoured with hops before fermenting.

Preferably, the process includes the further steps of maturation and filtration.

In a second aspect the invention provides a process for the production of a fermented product, the method including the step of enzymatically producing soluble dietary fibre from the digestible sugars ordinarily part of the brewing process.

Preferably, the soluble dietary fibre is derived from the transglycosylation of glucose or fructose.

Preferably, the soluble dietary fibre produced includes isomalto-oligosaccharides produced enzymatically by the enzyme D-glucosyltransferase (EC 2.4.1.24) or by the enzyme neopullanase, and/or, if fructo-oligosaccharides are to be produced in the fermented product, the enzyme fructosyltransferase is employed.

Preferably the enzyme is added during the mashing or wort preparation process.

Preferably, the isomalto-oligosaccharides are derived from maltose and/or malto oligosaccharides, and the maltose concentration, before enzymatic reaction, is maintained at above about 2%w/v, preferably between about 15% and 80% w/v and more preferably between 25% and 40%w/v.

Preferably, the isomalto-oligosaccharides include isomaltotriose, isomaltotetrose, isomaltopentose, isomaltohexose, 4-alpha-dextrantriosyl-D-glucose, 4-alpha-dextrantetrosyl-D-glucose, 4-alpha-dextranpentosyl-D-glucose, 6³-α-D-glucosyl maltotriose, panose and isomaltose.

Preferably, the process produces an additional 0.3 g/100 ml, more preferably 0.5 g/100 ml, and most preferably at least 0.7 g/100 ml of soluble dietary fibre.

Preferably, the product produced by the process contains at least about 2.5 g/100 ml of soluble dietary fibre and more preferably more than about 4 g/100 ml. More preferably the minimum amount of soluble dietary fibre produced is above about 0.3 g/100 ml.

Preferably the product also includes less than about 8.0 g/100 ml of digestible sugar.

Preferably, the product includes less than about 4.0 g/100 ml of digestible sugar, more preferably less than 2.0 g/100 ml.

In a third aspect the invention provides a fermented product including water, alcohol, less than about 4 g/100 ml of digestible sugars, and more than about 0.3 gm/100 ml of soluble dietary fibre.

Preferably the product contains more than 2.5 g/100 ml of soluble dietary fibre.

Preferably, the product includes less than about 2 g/100 ml of digestible sugar.

Preferably, the product includes more than about 4 g/100 ml of soluble dietary fibre.

Preferably, the soluble dietary fibre includes the non-digestible isomalto-oligosaccharides, and/or fructo-oligosaccharides.

In a fourth aspect the invention provides a fermented product including water, alcohol and more than about 0.3 g/100 ml of fructo-oligosaccharides and non-digestible isomalto-oligosaccharides.

Preferably the product contains more than about 0.7 g/100 ml and more preferably above about 2.5 g/100 ml of fructo-oligosaccharides and non-digestible isomalto-oligosaccharides.

Other aspects and embodiments of the present invention will become apparent from the following description given by way of example.

### DETAILED DESCRIPTION OF THE INVENTION

Fermented products are usually produced by a brewing process including the general technique of extracting a largely fermentable liquid, wort, from a mash containing malted barley and adjuncts, boiling of this wort, possibly flavouring the wort with hops, and fermenting this mixture with a yeast to produce beer. This is commonly followed by maturation, filtration and finally packaging if required.

The invention is directed generally to a brewing process for producing a product which contains a high content of soluble dietary fibre. This fibre is preferably produced enzymatically from the digestible sugars ordinarily part of the brewing process. It is possible to produce above about 0.3 g/100 ml, preferably about 0.5 mg/100 ml and preferably above 0.7 g/100 of additional soluble dietary fibre via this process. The lower amount of soluble dietary fibre produced may have a taste effect on the product that may be desirable, particularly when coupled with reduced digestible sugar content (as discussed later herein).

The invention is also directed to a product, which will usually be a beer, ale or other malt beverage (but could also include, but not be limited to, sake, wine, cider, fermented fruit juices etc), containing an increased content of soluble dietary fibre sufficient to meet dietary needs. It is preferred that such a product should have above about 2.5 g/100 ml soluble dietary fibre and preferably above about 4 g/100 ml. The product could have less soluble dietary fibre but this would mean that relatively large amounts of product would need to be consumed to obtain the desired beneficial effect.

The invention will also include a fermented product having a low digestible sugar content, and hence a lower calorie level, together with an increased content of soluble dietary fibre sufficient to result in a lower calorie product having acceptable taste characteristics. To obtain the acceptable taste characteristics, the lower calorie product should preferably have more than about 0.5 g/100 ml soluble dietary fibre but it is preferred that above about 2.5 g/100 ml is present as this is preferred for dietary reasons (as discussed herein). The lower calorie product will preferably include less than about 4.0 g/100 ml digestible sugar, and more preferably less than about 2.0 g/100 ml.

It has been found that it is possible to produce a fermented product with good consumer acceptability (acceptable taste, body and mouthfeel) coupled with an increased dietary fibre content. It has also been found that a lower calorie product with good consumer acceptability can be produced by lowering the digestible sugar content and replacing this, at least in part, with soluble dietary fibre, such as the non-digestible isomalto-oligosaccharides, and fructo-oligosaccharides.

IMO's such as panose and isomaltose have variable digestibility depending on dosage, concentration and digestion conditions and are thus less preferred options. To some extent therefore IMO's having a degree of polymerisation (DP) of 3 can be used but the IMO's having a DP of 4 or more are preferred.

By digestible sugar it is meant a sugar that can be utilised directly by the human digestion system for energy. Soluble dietary fibre has been defined previously herein. As will be readily apparent to a person skilled in this art, soluble dietary fibre, comprising as it does non-digestible carbohydrates, notably oligosaccharides, will also be non-fermentable. The process disclosed herein will therefore convert fermentable carbohydrates and sugars to non-fermentable oligosaccharides.

In order to achieve health benefits from the presence of dietary fibre it is preferred that the amount of the soluble dietary fibre is above about 2.5 g/100 ml of final product but the minimum is likely to be above 0.3 g/100 ml. Data from the literature is variable on the amount of IMO required for a functional use rate and even more inconsistent on the relative amounts of higher IMOs required but this level is preferred based on the information available and consumption of about 350 ml of product (i.e. about one standard can or small bottle). Alternatively the dose could be achieved by consuming 2 small bottles/cans with an appropriate adjustment in product content.

Kaneko et al (Biosci.Biotech.Biochem., 58(12),2288-2290, 1994) suggest an intake of 10 g/day of “IMO2”(DP1—glucose 0.6%; DP2's maltose 2.1%, isomaltose 63.8%, nigerose/kojiiose 22.6%; DP3's—maltotriose 0%, panose 6.5%, isomaltotriose 3.9%; DP4's—isomaltotetraose and others 0.5% ) produced a significant increase of bifidobacteria within 12 days.

Kaneko et al also stated that a higher DP syrup “IMO3” (DP1s—glucose 0.6%;DP2's—maltose 1.1%, isomaltose 2.7%, nigerose/kojibiose 1.5%; DP3's—maltotriose 4.2%, panose 27.7%, isomaltotriose 12.1%; DP4's—isomaltotetraose and others 30.7%; DP5's isomaltopentaose and others 8.3%; DP6's or greater—isomaltohexaose and others 11.1%.) produced a significant increase of bifidobacteria within 12 days with only a dose rate of 5 g/day.

Kohmoto et al (Biosci.Biotech.Biochem., 56(6), 937-940,1992 also demonstrated that the minimum dosage of IMO for increasing bifidobacteria was 8-10 g/day. This IMO syrup used had the composition DP1—glucose 2.4%; DP2's—maltose 3.6%, isomaltose 32.3%, nigerose/kojibiose 9.1%; DP3's—panose 12.3%, isomaltotriose 14.8%; DP4's—isomaltotetraose and others 15.5%; DP5's—isomaltopentaose and others 6.9%; DP6's—isomaltohexaose and others 3.3%. This paper also shows that about 75% of IMO's were digested, leaving 25% to pass through to the colon for fermentation by microflora. This 25% of IMO's effectively correlates to the proportion of DP4, or greater, IMO in the syrup.

As said above, the literature is varied on the required dose of soluble dietary fibre. It does, however, support the view that increased levels of soluble dietary fibre has a beneficial effect and that the amount of soluble dietary fibre in the form of at least DP4 IMO should be about 2-2.5 g per day. In fact the US Code of Federal Regulations recommend 6 g per day of soluble dietary fibre should be consumed. By providing a product having 2.5 g/100 ml soluble dietary fibre an effective increase of soluble dietary fibre consumed can be achieved without an over consumption of product relatively speaking. The minimum to achieve this end would probably be about 0.3 g/100 ml but this is a less preferred level due to consumption level and type of beer issues.

The preferred process according to this invention produces the soluble dietary fibre, such as isomalto-oligosaccharides (IMO) or fructo-oligosaccharides, enzymatically during the brewing process. If desired, the brewing process can be optimised so that the enzymatic reaction is biased toward the production of soluble dietary fibre. In this way the amount of digestible sugar is inherently reduced and the amount of soluble dietary fibre is increased.

In a preferred embodiment, the IMO is produced during the brewing process, preferably prior to fermentation and after malting, by the addition of an enzyme which is capable of producing IMO in situ during a desired step in the brewing process by either conversion of substrates which are present due to the brewing process itself or through the addition of suitable substrate (ie adjuncts) which is added as a distinct component during the brewing process.

The preferred stage of the brewing process at which the enzyme is added would be to the wort after extraction from the mash because at this stage the wort can be sidelined from the main process and held in an auxiliary brewing vessel for the lengthy enzyme reaction, thus increasing brewing efficiency. There could be a variety of alternatives, such as adding the enzyme during the mashing process itself. This, while an option, is less preferred due to the lower yield of isomalto-oligosaccharides due to lower maltose levels, restricted time available and greater difficulty incorporating the additional step into the brewing process.

In a particularly preferred process, D-glucosyltransferase (EC 2.4.1.24) can be used in the process to produce isomalto-oligosaccharides (IMO) having a high degree of polymerisation (DP) from appropriate maltose and/or malto-oligosaccharide substrates present in or which have been maximised in the wort. Another particularly preferred enzyme is fructosyltransferase (EC 2.4.1.10), which is effective for producing fructo-oligosaccharides (FOS). While D-glucosyltransferase and fructosyltransferase are preferred enzymes for producing soluble dietary fibre during brewing, due to their effect in catalysing the conversion of saccharides and/or oligosaccharides such as maltose and/or malto-oligosaccharides and fructose and/or fructo-oligosaccharides present during brewing to the more highly polymerised and desirable IMO products, any enzyme which is known to produce an equivalent result in the conversion of sugars or RR carbohydrate components present during brewing to soluble dietary fibre as described herein will be useful. Thus, for example when producing soluble dietary fibre enzymatically) the enzymes listed in Table 1 are useful in the production of IMO during brewing.

The enzymatic conversions suggested herein have the advantage of lowering the digestible sugar content while, at the same time, increasing the soluble dietary fibre content. Thus, through the inventive process, it is possible to use digestible wort sugars in the production of the soluble dietary fibre. However, as suggested in the non-limiting listing of exemplary enzymes provided in Table 1, it is also possible to add a specific substrate(s) during a desired stage of the brewing process. This added substrate serves as a substrate for an enzyme which is capable of converting the added substrate to the desired soluble dietary fibre.

The enzyme useful in the invention as described herein may be obtained from any source known to produce such enzymes. For example, it is possible to obtain suitable glucosyltransferases and fructosyltransferases from appropriate animal, microbial or plant sources. Preferably, where the enzyme is a fructosyltransferase, the source organism is Aspergillus niger or Aspergillus awamori and where the enzyme is glucosyltransferase the source organism is Aspergillus niger. However, it is expected that suitable enzymes may be obtained from many different types of organisms, including, for example, it is contemplated that the enzymes or the DNA encoding the enzyme used in the present invention may be derived from Absidia spp.; Acremonium spp.; Actinomycetes spp.; Agaricus spp.; Amerosporium spp., Anaeromyces spp.; Aspergillus spp., including A. auculeatus, A. awamori, A. flavus, A. foetidus, A. fumaricus, A. fumigatus, A. nidulans, A. niger, A. oryzae, A. terreus and A. versicolor; Aeurobasidium spp.; Bipolaris spp., Cephalosporum spp.; Chaetomium spp.; Coprinus spp.; Curvalaria spp., Dactyllum spp.; Erwinia spp., Fusarium spp., including F. conglomerans, F. decemcellulare, F. javanicum, F. lini, F.oxysporum and F. solani; Gliocladium spp.; Humicola spp., including H. insolens and H. lanuginosa; Myceliophthora spp., Myrothecium spp., Mucor spp.; Neurospora spp., including N. crassa and N. sitophila; Neocallimastix spp.; Orpinomyces spp.; Penicillium spp; Phanerochaete spp.; Phlebia spp.; Piromyces spp.; Pseudomonas spp.; Rhizopus spp.; Schizophyllum spp.; Streptomyces spp; Stachybotrys spp., Trametes spp.; and Trichoderma spp., including T. reesei, T. longibrachiatum and T. viride; and Zygorhynchus spp. Similarly, it is envisioned that an enzyme and/or DNA encoding an enzyme as described herein may be found in bacteria such as Bacillus spp., Actinomyces spp., Streptomyces spp., including S. olivochromogenes; specifically fibre degrading ruminal bacteria such as Fibrobacter succinogenes; and in yeast including Candida torresii; C. parapsilosis; C. sake; C. zeylanoides; Pichia minuta; Rhodotorula glutinis; R. mucilaginosa; and Sporobolomyces holsaticus.

In a particularly preferred embodiment, the enzyme is produced in high quantities through expression of the DNA encoding the enzyme in a recombinant host cell. Such expression techniques are well known in the art, and include the isolation of the DNA encoding the enzyme, the insertion of the DNA into a suitable vector which includes other important components such as a promoter, signal sequence, termination site and suitable markers and transformation of the vector into a suitable host cell capable of expression of the properly folded protein encoded by the vector DNA.

For example, the isolated DNA may be placed into either a self-replicating extrachromosomal vector or vectors which integrate into a host genome. As indicated above, these expression vectors include the transcriptional and translational regulatory nucleic acid operably linked to the nucleic acid encoding the desired enzyme activity. For example, DNA for a presequence or secretory leader is operably linked to DNA for a polypeptide if it is expressed as a preprotein that participates in the secretion of the polypeptide. In a preferred embodiment, when a naturally occurring secretory sequence leads to a low level of secretion of a variant protein, a replacement of the naturally occurring secretory leader sequence is desired. In this embodiment, an unrelated secretory leader sequence is operably linked to a variant protein encoding nucleic acid leading to increased protein secretion. Thus, any secretory leader sequence resulting in enhanced secretion of the desired enzyme, when compared to the secretion of the naturally occurring enzyme and it secretory sequence, is desired.

Methods of obtaining suitable secretory leader sequences that lead to the enhanced secretion of a protein are known in the art. Thus, transcriptional and translational regulatory sequences may include, but are not limited to, promoter sequences, ribosomal binding sites, transcriptional start and stop sequences, and enhancer or activator sequences.

The nucleic acids encoding the enzyme are then introduced into cells, generally in combination with an expression vector. The method of introduction is largely dictated by the targeted cell type and includes such methods as CaPO(4) precipitation, liposome fusion, lipofection, electroporation, viral infection etc . . . The nucleic acids may stably integrate into the genome of the host cell or may exist either transiently or stably in the cytoplasm through the use of e.g., traditional plasmids utilizing standard regulatory sequences and selection markers.

The enzymes of the present invention are produced by culturing a host cell transformed either with an expression vector containing nucleic acid encoding the protein or with the nucleic acid encoding the protein alone, under appropriate conditions to induce or cause expression of the protein. The conditions appropriate for protein expression will vary with the choice of the expression vector and the host cell, and will be easily ascertained by one skilled in the art through routine experimentation. For example, the use of constitutive promoters in the expression vector will require optimizing the growth and proliferation of the host cell, while the use of inducible promoter requires appropriate growth conditions for induction. Appropriate host cells include yeast, bacteria, filamentous or other fungi, insect and animal, including mammalian, cells.

D-glucosyltransferase (EC 2.4.1.24) is the preferred enzyme for producing soluble dietary fibre, catalysing the conversion of maltose and or malto-oligosaccharide (substrate) to the more highly polymerised isomalto-oligosaccharides (product)”. Fructosyltransferase is preferred for producing fructo-oligosaccharides. These preferred options have the advantage of lowering the digestible sugar content while, at the same time, increasing the soluble dietary fibre content.

Thus the process uses the normal digestible wort sugars in the production of the soluble dietary fibre.

Commercial enzymatic process using specific transferases are available to manufacture oligosaccharides of various types such as isomalto-oligosaccharide (IMO) and cyclo-dextrins from starch, fructo-oligosaccharide (FOS) from sucrose and galacto-oligosaccharide (GOS) from lactose, see Table 1 (Crittenden, R. G. and Playne, M. J. 1996, Trends in Food Science and Technology, November, Vol 7, pages 353-361). These oligosaccharide are non-cariogenic, low-calorie and stimulate the growth of beneficial bacteria in the colon.

Table 1 (below) shows a list of oligosaccharides together with a list of substrates for their formation and whether that substrate is available in wort/beer. Also shown is a list of preferred enzymes which could be used to catalyse the substrate transfer.

TABLE 1

| | | | ENZYMES USED TO PRODUCE | |
|---|---|---|---|---|
| | | | THESE IN BREWING | |
| | | | | Examples of |
| | | SUBSTRATE | | specific |
| | | IN | | preferred |
| OLIGOSACCHARIDE | SUBSTRATE | WORT/BEER | Enzyme Type | enzymes |
| Isomaito- | Maitose/maito- | Yes | Glucosyltransferases | D-glucosyl |
| oligosaccharide | oligosaccharides | | | transferase |
| | | | | neopullanase |
| Fructo- | Sucrose | Yes | Fructosyltransferases | Levanase |
| oligosaccharide | | | | |
| Galacto- | Lactose | No | Galactosyl | |
| oligosaccharides | | | transferases | |
| Xylo- | Xylan | Yes | Endo-1, 4, beta- | |
| oligosaccharides | | | xylanase | |
| Lactulose | Lactose | No | | |
| Lactosucrose | Lactose | No | | |
| Palatinose | Sucrose | Yes | Isomaltulose synthase | |
| oligosaccharides | | | | |
| Gentio- | Glucose | Yes | Transglucsoylases | |
| oligosaccharides | | | | |
| Cyclodextrins | Soluble starch | Yes | Cyclodextrin glucosyl | |
| | | | transferase | |

Fermented products generally contain a relatively high amount of calories, the majority of which are contained within the alcohol portion of the product. However, a significant amount of residual calories are contained in digestible sugars that remain in the product following the fermentation process. Removal of these digestible sugars by an extended brewing process (long brewing) converts most of these sugars to alcohol and lowers the caloric content. However, extended brewing tends to result in a product which is generally considered to lack flavour, body and mouthfeel and, therefore, has reduced consumer acceptability.

Soluble dietary fibre, such as the non-digestible isomalto-oligosaccharides, promotes flavour, body and mouthfeel to a beer without providing utilisable calories, thus providing a mechanism for producing a satisfactory tasting lower calorie beer, having a reduced amount of digestible sugar and an increased amount soluble dietary fibre. This fibre is usually present in fermented products but in relatively low amounts. Therefore, the simple removal of the digestible sugars will not promote acceptable taste in a low calorie beer, it is necessary to increase the soluble dietary fibre content in the product to a level that allows the acceptable taste to be achieved. This occurs to some extent from about 0.3 g/100 ml to about 0.5 g/100 ml of non-digestible sugar (i.e. soluble dietary fibre) in the final product although above 2.5 g/100 ml is preferred both for consumer acceptability and for dietary reasons as discussed above.

In one preferred form therefore, the present invention is directed to a fermented product which contains a low amount of digestible sugars while retaining the taste qualities of body and mouthfeel of fermented products having traditional concentrations of digestible sugars. In a preferred form the taste qualities are achieved by including an amount of soluble dietary fibre which, in addition to taste, can provide a number of beneficial effects to the consumer.

The process can be optimised so that, if desired, the residual amounts of digestible sugars that remain at the end of the fermentation process can be also removed by either extending the fermentation time or by adding a specific yeast or yeasts that target digestible sugars such as maltotriose and isomaltose and the semi-digestible sugar panose.

One option to minimise the presence of residual digestible sugars is to use a yeast/s which can selectively ferment remaining digestible sugars to alcohol and thus remove them from the brewing mixture to ensure that the calorie content in the final product arising from digestible sugars is minimal.

By combining the removal of residual digestible sugars from the final product and by increasing the soluble dietary fibre (as defined previously) a fermented beverage is produced which combines a lower calorie content, together with the benefits of the presence of an increased content of soluble dietary fibre.

Increased levels of soluble dietary fibre (e.g. isomalto-oligosaccharides and/or fructo-oligosaccharides) can be produced in the wort or beer via the use of specific enzymes which will act on the digestible sugar substrate contained in the brew to produce these oligosaccharides of lesser digestibility. To produce this sugar substrate, e.g. maltose, there are several potentially useful enzymes which may be added to the wort or beer during the brewing process to produce a high level of maltose from wort malto-oligosaccharides (e.g. Barley Beta Amylase, Pullulanase). This would then be followed by transglucosylation of the maltose (e.g. using D-glycoslytransferase ) or alternatively transfructosylation of sucrose (e.g. using fructosyltransferase).

D-glucosyl transferase produces isomalto-oligosaccharides by the following reactions:

Step 1 Formation of Glucosyl-Enzyme Complex

Maltose(G-G)+Enzyme+Enzyme→Glucose Complex (E-G)+Glucose(G)

Step 2 Glucosyl Transfer

Primary reaction Maltose(G-G)+E-G→Panose (DP3)+E

Secondary reactions Glucose(G)+E-G+Isomaltose(DP2)+E

Panose(DP3)+E-G→Dextran Triosyl-D-glucose

(DP4)+E

Isomaltose +E-G→Isomaltotriose(DP3)+E

It can be seen that a high initial maltose concentration is required for step 1 so as to provide sufficient Enzyme-Glucose complex for all the subsequent reactions.

A standard brewing process (through to packaging) will ordinarily consist at least of the following steps:

1. Milling of malted barley into a mash

2. Conversion of starch in the mash to fermentable sugars largely by enzymes from the malt

3. Filtration of the mash to produce a liquid called wort comprised of fermentable and unfermentable sugars

4. Collection of wort into a wort collection kettle

5. Boiling of this wort in a boiling kettle. This step may/may not include addition of hops or adjuncts such as additional sources of sugars (e.g. sucrose, maltose syrups)

6. Cooling of the wort

7. Fermentation, -yeast is added and fermentable sugars are converted into CO2 and alcohol.

8. Maturation

9. Filtration

10. Packaging

It will be recognised that, in terms of brewing per se, steps 8, 9, 10 are additional steps.

The process according to the present invention will preferably include the following additional steps in the above standard process:

2a preferably addition of Barley Beta amylase and pullulanase and other such enzymes to achieve a highly fermentable wort and one that is higher in ratio of maltose/maltotriose and lower in glucose.

3a may include modified filtration procedures so that a stronger 1^{st} wort is achieved.

4a may include addition of a high maltose syrup

4b cooling to reaction temperature and pH adjustment

4c reaction of the wort for sufficient time (approximately 2 hrs for a high volume consumption beer to approximately 8 hrs for low volume consumption beer) with the selected enzyme to produce the high level soluble dietary fibre (e.g. enzyme D-glucosyl transferase to produce isomalto-oligosaccharides).

7a preferably use of a yeast specially selected to also ferment isomaltose/panose so as leave only higher DP IMOs so that the additional benefits of lower calories as well as high levels of soluble dietary fibre beer are produced.

The following are considered to be preferred process parameters for D-glucosyl transferase enzyme (transglucosidase L-500 available from Genencor International Inc.) use:

sufficient enzyme dose rate, of about 1 to 8-10 TGU units/per g dry solids (higher (14-16 TGU) for a lower volume consumption beer);

temperature optimum range of between about 55-65° C.;

pH optimum range of between about 4-6. Preferably 4.5-5.5;

preferred addition point of D-glucosyl transferase to the process is to the wort after the wort filtration process (the lauter). In a preferred form this wort will have the maltose maximised;

sufficient reaction time to achieve the required amount of higher isomalto-oligosaccharides;

preferably maintaining the maltose concentration above about 2%w/v, preferably between about 15-80% and more preferably between 25% and 40%, prior to enzymatic conversion.

It would of course be possible to add a commercially available high IMO syrup to the brewing process or some part of it as an alternative way to adding IMO to the beer (eg Sapporo) as has been discussed previously herein, to achieve the dietary fibre health effect, then the product consumed would need to provide the consumer with an additional amount of soluble non-digestible dietary fibre to complement the normal diet. This would likely require about 0.7 g/100 ml of soluble non-digestible dietary fibre in a 350 ml bottle if two bottles were to be consumed daily. Known products (eg Sapporo, which included high levels of digestible sugars) with the aim of affecting taste only will not readily achieve this.

However, if it were desired to add a syrup and produce a lower calorie beer with sufficient soluble dietary fibre, then instead of adding the fibre anywhere in the brewing process it would need to be added prior to fermentation and in a manner that would ensure it was sterile. The selected yeast would then ferment the majority of the digestible sugars introduced by the IMO syrup, thus leaving the less digestible higher DP IMO sugars that have earlier been defined as soluble dietary fibre.

### EXAMPLES

### Example 1

### Comparison of Worts Required for D-Glucosyl Transferase Reaction

TABLE 2
Comparison of Worts
The table below demonstrates the difference in wort composition
required for producing a wort for subsequent reaction with
D-glucosyl transferase.
HPLC results expressed in g/100 ml

| | | | | | | | Total |
|---|---|---|---|---|---|---|---|
| | Glucose | Fructose | Sucrose | Maltose | Malto-triose | Other | extract |
| Normal | 1.3 | 0.2 | 3.3 | 5.3 | 1.1 | 4.4 | 15.6 |
| Brewing | | | | | | | |
| wort | | | | | | | |
| Maximised | 4.4 | 0 | 0 | 26.5 | 11.4 | 17.4 | 59.5 |
| maltose | | | | | | | |
| wort | | | | | | | |

Normal brewing wort was produced by milling malted barley and mashing this at 45° C. at 25%w/v in a mash with brewing water.

Temperature was held for 20 mins, then the temperature raised at 1° C./min to 70° C. It was held at this temperature for saccharification for 50 mins, then raised to 76° C. The mash was then filtered by lautering into the brewing kettle. Liquid sugar at 67°brix was then added to achieve 20% of the total extract then the wort was boiled for 90 mins, then cooled and diluted with brewing water to achieve 15.6 g extract per 100 ml wort.

Maximised maltose wort was produced by milling malted barley and mashing in at 45° C. at 30%w/v in a mash of brewing water. Temperature was held for 20 mins. Exogenous enzymes were also added to assist maltose maximisation. Temperature was then raised to 63° C. at 1° C./min and held for 100 mins. It was then raised to 72° C. for saccharification for 45 mins. The mash was then filtered by lautering into the brewing kettle but techniques were employed to increase the strength of this wort from the normal 14 g extract/100 ml to 25 g extract/1000 ml. This wort was then boiled for 15 mins to de-activate any residual activity. A high maltose syrup containing 51.5 g/100 ml maltose was then added to bring the maltose level of the resulting mixture to 26.5 g/100 ml wort. Total extract was now 59.5 g/100 ml wort.

Note HPLC analysis was as per method in example 2 below.

### EXAMPLE 2

### Enzymatic Reaction of Wort with D-Glucosyl Transferase

500 g of maximised maltose wort as produced in example 1 was adjusted to pH 5.0 and heated to 60° C. in a mash bath and held at that temperature for the rest of the experiment. 0.625 g of D-glucosyl transferase enzyme (Transglucosidase L-500 available from Genencor International Inc) was added to this. 5 ml samples were removed at 0,4,8,12 and 24 hr intervals. These were cooled immediately to 0° C. and kept at this prior to analysis by HPLC analysis.

High Performance Liquid Chromatography (HPLC) was used to determine the quantity of the isomalto-oligosaccharides.

25 microliters were injected into the HPLC, and the content of oligosaccharide was determined by comparison of peak areas to that of a standard substance.

HPLC equipment and conditions were as follows:—Detection device:—Refractive Index Detector

Column:—Supelcosil LC-NH2 25 cm×4.6 mm 5 micron particle size held at 25° C.

Solvent:—Acetonitrile:water 75:25 at a flow rate of 1 mL/min

Results of this analysis are attached below:

TABLE 3
HPLC Data for reaction of D Glucosyl Transferase with a
maltose maximised wort
HPLC results expressed in g/100 ml

| | Glu- | Mal- | | Malto- | | Isomalto- | |
|---|---|---|---|---|---|---|---|
| Hours | cose | tose | Isomaltose | triose | Panose | triose | DP4 |
| 0 | 4.5 | 26.5 | Tr | 11.4 | 0.8 | 1.3 | 0.5 |
| 4 | 11.1 | 3.1 | 11.7 | 1.5 | 9.9 | 2.5 | 4.1 |
| 8 | 11.8 | 2.4 | 11.0 | 1.0 | 9.5 | 2.6 | 3.9 |
| 12 | 13.4 | 2.9 | 11.1 | 1.2 | 9.7 | 2.7 | 4.2 |
| 24 | 15.3 | 2.7 | 11.4 | 0.6 | 6.2 | 3.5 | 5.3 |

Functional Dose Rates of Isomalto-Oligosaccharide (IMO) as Dietary Fibre

The data from the Table 3 above can be reformatted into IMO's of DP2, DP3 and DP4/DP4+. The total extract of this wort was 59.5 g/100 ml with the additional extract being non fermentable but digestible dextrins from the breakdown of starch within the malt. Data in Table 4 below is expressed in g/100 ml.

TABLE 4

| | | | | | Total |
|---|---|---|---|---|---|
| | Extract | DP2 IMO | DP3 IMO | DP4 IMO | IMO |
| Final wort | 59.5 | 11.4 | 9.7 | 5.3 | 26.4 |
| from table | | | | | |
| above | | | | | |
| (24 hrs) | | | | | |
| In wort at | 15.6 | 2.9 | 2.3 | 1 .38 | 6.86 |
| Pitching | | | | | |
| In beer at | 10.4 | 1.97 | 1.68 | 0.91 | 4.57 |
| 4% v/v | | | | | |
| alcohol | | | | | |
| IMO | | 19.7 g | 16.8 g | 9.1 g | 45.7 g |
| consumed if | | | | | |
| drink 1 litre | | | | | |
| beer per day | | | | | |

The products in Table 4 above will deliver sufficient IMO for functionality as a soluble dietary fibre as described previously herein by Kaneko et al and Kohmoto et al.

### Example 3

### Enzymatic Reaction of Wort with D-Glucosyl Transferase

13.7 litres of maximised maltose wort as produced in example 1 were adjusted to pH 5.0 and heated to 60° C. in a pilot plant kettle and held at that temperature for the rest of the experiment. 41.75 g of D-glucosyl transferase enzyme (Transglucosidase L-500 available from Genencor International Inc) was added to this. 10 ml samples were removed at 0, 2 and 4 hr intervals. These were cooled immediately to 0° C. and kept at this prior to analysis by HPLC analysis. HPLC analysis was as in Example 2 above. Results of this analysis are attached below:

TABLE 5
HPLC Data from Pilot Plant brew reaction of D Glucosyl
Transferase with a Maltose Maximised Wort.

| | | | | | | | | | | | |
|---|---|---|---|---|---|---|---|---|---|---|---|
| | | | | | | | | | | Dextran- | Iso- |
| | | | | | Iso- | Malto- | | Iso-maltro- | Malto- | 3- | malto- |
| Sample | Frutose | Glucose | Sucrose | Maltrose | maltose | triose | Panose | triose | tetrose | Glucose | tetrose |

HPLC results expressed in g/100 ml

| | | | | | | | | | | | |
|---|---|---|---|---|---|---|---|---|---|---|---|
| Wort at | 0.19 | 3.79 | 0.43 | 30.63 | 0.00 | 10.77 | 0.25 | 0.00 | 0.92 | 0.28 | 0.00 |
| 0 hrs. | | | | | | | | | | | |
| No Enz | | | | | | | | | | | |
| Wort | 0.18 | 8.02 | 0.31 | 15.67 | 4.62 | 7.22 | 7.77 | 0.30 | 0.91 | 1.77 | tr |
| 2.25 hrs | | | | | | | | | | | |
| after | | | | | | | | | | | |
| Enz | | | | | | | | | | | |
| added | | | | | | | | | | | |
| Wort 4 | Tr | 8.98 | 0.28 | 14.09 | 4.77 | 6.39 | 9.16 | 0.54 | 0.76 | 1.97 | 0.38 |
| hrs after | | | | | | | | | | | |
| Enz | | | | | | | | | | | |
| added | | | | | | | | | | | |

Functional Dose Rates of IMO as Dietary Fibre

The data from Table 5 can be reformatted into IMO's of DP2, DP3 and DP4/DP4+. The total extract of this wort was 60.5 g/100 ml with the additional extract being non fermentable but digestible dextrins from the breakdown of starch within the malt. Data in Table 6 below are expressed in g/100 ml.

TABLE 6

| | | DP2 | DP3 | DP4 | Total |
|---|---|---|---|---|---|
| | Extract | IMO | IMO | IMO | IMO |
| Final wort | 60.5 | 4.77 | 9.7 | 2.35 | 16.82 |
| from table | | | | | |
| above, after 4 | | | | | |
| hrs enz. | | | | | |
| In wort at | 15.6 | 1.24 | 2.5 | 0.61 | 4.33 |
| Pitching | | | | | |
| In beer at | 10.4 | 0.83 | 1.67 | 0.41 | 2.88 |
| 4% v/v alcohol | | | | | |
| IMO | | 8.3 | 16.7 | 4.1 | 28.8 |
| consumed if | | | | | |
| drink 1 litre | | | | | |
| beer per day | | | | | |

The figures here are lower than that in Table 4 but within the amount and ratio of IMO DP 3/4 to achieve 5-10 g/day of IMO. Also it is within the amount and ratio to achieve 2.5 g per day of DP4 IMO.

Conditions were adjusted in this example to yield a faster reaction and higher ratio of panose to isomaltose.

In summary both Examples 2 and 3 demonstrate that the enzymatic process does deliver a product containing sufficient soluble dietary fibre as IMO to produce a product to deliver a functional increase in bifidobacteria.

### Example 4

### Optimisation of the Enzymatic Reaction Conditions

Reaction conditions can be optimised to either better fit in with the brewing cycle or cost constraints (eg enzyme cost) or altered to provide different levels of non digestible IMO in the final beer - depending on final beer strength, type, and amount targeted for daily consumption.

Another experiment with conditions similar to Example 2 was undertaken. Changes to Example 2 were that the maximised maltose wort was altered to achieve 38.9% w/v as is (by HPLC) of maltose instead of 26.5% maltose. This was done by altering the ratio of wort and maltose syrup. Reaction conditions namely amount of TransglucosidaseL-500 enzyme was different. Results and reaction conditions are in Table 7. This shows how time and enzyme concentration may be altered to alter yield of IMOs for the purposes described above.

TABLE 7

| | | | | | | | Iso | | | | |
|---|---|---|---|---|---|---|---|---|---|---|---|
| HPLC | | | | Iso | Malto | | Malto | Malto | DP4a | DP4b | Malto |
| % w/v | | Glu | Maltose | Maltose | triose | Panose | triose | tetraose | IMO | IMO | pentose |
| Effect of | 0 | 3.4 | 38.9 | 1.1 | 14.3 | 0.3 | 0 | 0.7 | 0.4 | 0 | 1.4 |
| Time | hrs | | | | | | | | | | |
| | 4 | 9.1 | 15.3 | 4.4 | 7.6 | 10.6 | 0.6 | 0.6 | 2.3 | 0.4 | 1.4 |
| | hrs | | | | | | | | | | |
| | 8 | 12.5 | 8.1 | 8.2 | 3.8 | 14.4 | 1.6 | 0.4 | 3.7 | 1.6 | 1.4 |
| | hrs | | | | | | | | | | |
| Reaction Conditions: pH 5.0, temperature 60° C., Transglucosidase L-500 used was 1.37 ml per 500 g reaction mixture (equivalent to 4522 units of Transglucosidase L-500 per kg maltose), maltose start concentration 38.9%. | | | | | | | | | | | |
| Effect | −25% | 8.1 | 20.2 | 3.9 | 9.2 | 9.1 | 0 | 0.7 | 2.1 | 0 | 1.3 |
| of TG | Target | 9.1 | 15.3 | 4.4 | 7.6 | 10.6 | 0.6 | 0.6 | 2.3 | 0.4 | 1.4 |
| Conc. | +25% | 10.2 | 12.2 | 6.0 | 6.2 | 11.8 | 0.6 | 0.6 | 2.9 | 0.5 | 1.3 |

Reaction Conditions: pH 5.0, temperature 60° C., Target Transglucosidase L-500 used was 1.37 ml per 500 g reaction mixture (equivalent to 4522 units of Transglucosidase L-500 per kg maltose), maltose start concentration 38.9%. Reaction time 4 hrs.

The next Example will demonstrate that an acceptable beer containing this IMO was produced.

### Example 5

### Fermentation to Produce a Beer Containing Soluble Dietary Fibre

The reacted wort from Example 3 was increased in volume from 13.7 litres to 40 litres and raised to boiling temperature. Hops were added after 20 mins to achieve 15EBU and the wort was boiled for 90 mins in total. It was then transferred to a whirlpool, then cooled to 11° C. and diluted with brewing water to 15.6 g/100 ml of extract in the wort. It was then pitched with brewing yeast and fermented at 13° C. for 12 days until fermentation complete. Samples were taken of the initial wort before pitching and every 2-3 days through fermentation and were analysed by HPLC as in the method describe above, results are in Table 8 below.

TABLE 8
Data from Pilot Plant Brew Fermentation

| | | | | | | | | | | | |
|---|---|---|---|---|---|---|---|---|---|---|---|
| | | | | | | | | | | Dextran- | Iso- |
| | | | | | Iso- | Malto- | | Iso-maltro- | Malto- | 3- | malto- |
| Sample | Frutose | Glucose | Sucrose | Maltrose | maltose | triose | Panose | triose | tetrose | Glucose | tetrose |

HPLC results expressed in g/100 ml

| | | | | | | | | | | | |
|---|---|---|---|---|---|---|---|---|---|---|---|
| Wart @ | tr | 2.28 | 0.08 | 4.08 | 0.61 | 1.43 | 2.37 | tr | 0.19 | 0.60 | tr |
| 1060 | | | | | | | | | | | |
| Jun. 4, | | | | | | | | | | | |
| 2000 | | | | | | | | | | | |
| 21:30 | | | | | | | | | | | |
| Fer- | 0.00 | Tr | 0.00 | 0.32 | 0.62 | 0.97 | 2.38 | tr | 0.18 | 0.58 | tr |
| menter | | | | | | | | | | | |
| after | | | | | | | | | | | |
| 82 hrs | | | | | | | | | | | |
| Fer- | 0.00 | Tr | 0.00 | 0.07 | 0.56 | 0.42 | 2.35 | tr | 0.18 | 0.57 | tr |
| menter | | | | | | | | | | | |
| after | | | | | | | | | | | |
| 154 hrs | | | | | | | | | | | |
| Fer- | 0.00 | Tr | 0.00 | tr | 0.54 | 0.24 | 2.33 | tr | 0.20 | 0.59 | tr |
| menter | | | | | | | | | | | |
| after | | | | | | | | | | | |
| 250 hrs | | | | | | | | | | | |
| Fer- | 0.00 | Tr | 0.00 | tr | 0.54 | 0.23 | 2.33 | tr | 0.20 | 0.55 | tr |
| menter | | | | | | | | | | | |
| after | | | | | | | | | | | |
| 300 hrs | | | | | | | | | | | |

From the data in Table 8 it can be seen that the fermentable sugars have been converted into alcohol/CO₂ as per expected but that the IMO (isomaltose, panose and dextran-3-glucose ) is mostly unused by the yeast, therefore a beer with sufficient soluble dietary fibre has been produced. The relative amounts of IMO in the final beer are shown in Table 9 below. (note the final beer is at 3.85%v/v alcohol versus 4.51%v/v at the end of fermentation

TABLE 9

| | IMO | G/L of beer |
|---|---|---|
| DP2 | Isomaltose | 4.6 |
| DP3 | Panose | 19.8 |
| DP4 | Dextran-3-glucose | 4.6 |

This beer was then matured, filtered and packaged in the normal way. Comparison of analysis to a standard commercial beer is made in Table 10 below.

TABLE 10
Final Beer Comparison

| | | Standard | |
|---|---|---|---|
| Analyte | Units | Commercial | Trial beer |
| PH | | 4.27 | 3.82 |
| Colour | °EBC | 16.0 | 14.4 |
| Bitterness | °EBU | 15.6 | 15 |
| Original Extract | °Plato | 8.98 | 12.5 |
| Apparent Extract | °Plato | 1.63 | 5.44 |
| Alcohol | % v/v | 3.85 | 3.81 |
| Real Extract (total | % w/w | 3.02 | 6.81 |
| carbohydrate sugars) | | | |
| Diacetyl | Mg/L | 0.02 | 0.01 |
| CO₂ | g/L | 5.05 | 5.06 |
| Head Retention | Sec | 131 | 89 |
| Calcium | Mg/L | 45 | 51 |
| SO₂ | Mg/L | 10.4 | 13.0 |
| O° Haze-immediate | °EBC | 0.43 | 0.35 |
| Taste score | | 5.3 | 5.0 |
| (scale 1-9) | | | |
| Taste description | | Estery/fruity | Estery/fruity |
| | | | Slightly hoppy |
| | | Malty | Malty |
| | | Medium body | Medium body |
| | | Balanced sweet to | Balanced sweet to |
| | | bitter ratio | bitter ratio |
| | | Slightly astringent | Slightly astringent |
| Total IMO | % w/v | 0-0.2 | 2.9 |

One noticeable difference is the higher levels of extract, a higher OE, RE and AE is shown due to presence of the non-fermentable IMO's.

On blind tasting by a trained taste panel a sweetness or body increase was not detected in the trial beer despite the higher amount of sugars present.

An acceptable and comparative tasting beer was produced that contained sufficient levels of IMO as a source of soluble dietary fibre.

### Example 6

### Conversion of High Soluble Fibre/High Residual Sugar Beer to that of High Soluble Fibre/Low Residual Sugar

The above example (Example 5) can be reproduced with higher levels of IMO and then fermented with selected yeasts to achieve fermentation of the isomaltose and panose leaving only the DP4s and above. Thus achieving a lower calorie beer also with a functional amount of soluble dietary fibre.

It is known that there are brewing yeasts that can ferment maltotriose fully and literature (Gilliland, European Brewing Congress, 1970) suggests that some yeasts can ferment panose and isomaltose, contrary to statements made by Sapporo (above).

A standard wort was produced from maximised maltose wort and IMO syrups so as to produce a large amount of reproducible wort, similar to that used for fermentation in Example 5, to allow many fermentation trials.

This was made in the ratio of 20 kg of normal brewery wort (as in Table 2), 4 kg of IMO 500 syrup and 1 kg of IMO 900 syrup. This was then diluted to 18.5°Plato.

5 litre flask fermentations of this were inoculated with 20 million yeast cells/ml of many different yeasts and the fermentation performance and sugar profile monitored. Results of just a few of these are shown for comparison in Table 11.

TABLE 11

| | Final % | | | | | |
|---|---|---|---|---|---|---|
| HPLC | apparent | | | Malto | | Isomalto |
| % w/v | fermentation | Maltose | Isomaltose | triose | Panose | triose |
| Start | 0 | 4.62 | 0.86 | 1.86 | 1.58 | 0.24 |
| wort | | | | | | |
| Yeast 2 | 53.9 | 0.92 | 0.92 | 0.92 | 1.46 | 0.26 |
| Yeast 3 | 60.6 | 0.22 | 0.93 | 0.57 | 1.39 | 0.22 |
| Yeast14 | 81.8 | 0 | 0 | 0 | 0.21 | 0.17 |
| Yeast | 79.3 | 0 | 0 | <0.07 | 0.52 | 0.23 |
| 18 | | | | | | |

It can be seen that the standard brewing yeasts (2 & 3), did not fully ferment the maltotriose and did not ferment the isomaltose or panose. However yeasts 14 & 18 fermented all the isomaltose and most of the panose. Thus these lower DP reaction products from the transglucosylation reaction which are considered digestible or at best semi-digestible and not classified as non digestible soluble dietary fibre are effectively removed from the beer resulting in a lower calorie beer as well.

Where in the forgoing description reference has been made to integers having known equivalents, those integers are herein incorporated as if individually set forth.

It is to be appreciated that variations or modifications may be made to the examples and embodiments described, without departing from the spirit or scope of the invention as defined in the appended claims.

1. A brewing process for making a fermented product having an increased dietary fibre content, the process including the step of producing an additional component of soluble dietary fibre at a selected stage or stages in the process after malting.

2. The process according to claim 1 wherein the process produces at least an additional 0.3 g/100 ml of soluble dietary fibre.

3. The process according to claims 1 or 2 wherein the soluble dietary fibre produced in the brewing process includes the non-digestible isomalto-oligosaccharides, and/or fructo-oligosaccharides.

4. The process according to claim 3 wherein the isomalto-oligosaccharides produced include one or more of isomaltotriose, isomaltopentose, isomaltohexose, 4-alpha-dextrantriosyl-D-glucose, 4-alpha-dextrantetrosyl-D-glucose, 4-alpha-dextranpentosyl-D-glucose, 6³-α-D-glucosyl maltotriose, panose and isomaltose.

5. The process according to any one of the preceding claims wherein the soluble dietary fibre is produced enzymatically during the brewing process.

6. The process according to claim 5 wherein the soluble dietary fibre is derived from the transglycosylation of glucose or fructose.

7. The process according to any one of claims 1 to 5 wherein the soluble dietary fibre is an isomalto-oligosaccharide produced enzymatically from maltose and/or malto-oligosaccharides, in which process the maltose is maintained at above about 2%w/v prior to enzymatic conversion.

8. The process according to claim 7 wherein the maltose is maintained between 15% and 80% in the mix prior to enzymatic conversion.

9. The process according to any one of claims 5 to 8 wherein the enzyme is added during wort preparation.

10. The process according to any one of claims 1 to 9, including the steps of selectively substantially removing the digestible sugars either by adding a yeast which selectively ferments digestible sugars or by extending the fermentation process sufficiently to ferment remaining digestible sugars.

11. The process according to any one of claims 1 to 10, including the steps of preparation of a mash containing malted barley and adjuncts, extracting wort from the mash, boiling the wort, and fermenting the wort with a yeast to produce beer.

12. The process according to claim 11 wherein the wort is flavoured with hops before fermenting.

13. The process according to claim 11 or 12 further including the steps of maturation and filtration.

14. A fermented product produced by the process according to any one of the preceding claims, the product containing at least about 0.3 g/100 ml of soluble dietary fibre.

15. A fermented product according to claim 14 wherein the product contains at least about 2.5 g/100 ml of soluble dietary fibre.

16. A product according to claims 14 or 15 further including less than about 8.0 g/100 ml of digestible sugar.

17. A product according to any one of claims 14 to 16, including less than about 4.0 g/100 ml of digestible sugar.

18. A process for the production of a fermented product, the process including the step of enzymatically producing soluble dietary fibre from the digestible sugars ordinarily part of the brewing process.

19. The process according to claim 18 wherein the enzyme is added during wort preparation.

20. The process according to claim 18 or 19 wherein the soluble dietary fibre is derived from the transglycosylation of glucose or fructose.

21. The process according to any one of claims 18 to 20 wherein the soluble dietary fibre produced includes isomalto-oligosaccharides produced enzymatically by the enzyme D-glucosyltransferase (EC 2.4.1.24) or by the enzyme neopullanase, and/or, if fructo-oligosaccharides are to be produced in the fermented product, the enzyme fructosyltransferase is employed.

22. The process according to claim 21 wherein the isomalto-oligosaccharides are derived from maltose and or malto-oligosaccharides, and the maltose concentration, before enzymatic reaction, is maintained at above about 2%w/v.

23. The process according to claim 22 wherein the maltose concentration is maintained between about 15% and 80% w/v.

24. The process according to any one of claims 21 to 23 wherein the isomalto-oligosaccharides include any one or more of isomaltotriose, isomaltotetrose, isomaltopentose, isomaltohexose, 4-alpha-dextrantriosyl-D-glucose, 4-alpha-dextrantetrosyl-D-glucose, 4-alpha-dextranpentosyl-D-glucose, 6³-α-D-glucosyl maltotriose, panose, and isomaltose.

25. The process according to any one of claims 18 to 24 wherein the process produces at least an additional 0.3 g/100 ml of soluble dietary fibre.

26. The process according to claim 25 producing at least about 0.5 g/100 ml soluble dietary fibre.

27. A product produced by the process according to any one of claims 18 to 25 wherein the product contains above about 0.3 g/100 ml soluble dietary fibre.

28. A product produced by the process according to any one of claims 18 to 26 wherein the product contains at least about 2.5 g/100 ml soluble dietary fibre.

29. A product according to claim 27 or 28 wherein the product also includes less than about 8.0 g/100 ml of digestible sugar.

30. A product according to any one of claims 27 to 29 wherein the product includes less than about 4.0 g/100 ml of digestible sugar.

31. A fermented product including water, alcohol, less than about 4 g/100 ml of digestible sugars, and more than about 0.3 g/100 ml of soluble dietary fibre.

32. The product according to claim 31 wherein the product contains more than about 2.5 g/100 ml of soluble dietary fibre.

33. The product according to claim 31 or 32 wherein the product includes less than about 2 g/100 ml of digestible sugar.

34. The product according to claims 31 to 33 wherein the product includes more than about 4 g/100 ml of soluble dietary fibre.

35. The product according to any one of claims 31 to 34 wherein the soluble dietary fibre includes non-digestible isomalto-oligosaccharides, and/or fructo-oligosaccharides.

36. A fermented product including water, alcohol and more than about 0.3 g/100 ml of fructo-oligosaccharides and/or non-digestible isomalto-oligosaccharides.

37. The product according to claim 36 wherein the product contains more than about 0.7 g/100 ml of fructo-oligosaccharides and/or non-digestible isomalto-oligosaccharides.

38. A process for producing a fermented product substantially as herein defined with reference to any one of the Examples.

39. A fermented product substantially as herein defined with reference to any one of the Examples.
